(19) United States
(12) Patent Application Publication
(10) Pub. No.: US 2019/0265550 A1
(43) Pub. Date: Aug. 29, 2019

(54) LIGHT-EMITTING DEVICE, BACKLIGHT DEVICE, AND LIQUID CRYSTAL DISPLAY DEVICE

(71) Applicant: SHARP KABUSHIKI KAISHA, Sakai City (JP)

(72) Inventors: HIROSHI KITAMURA, Sakai City (JP); HIDEKAZU FUJII, Sakai City (JP); MAKOTO AGATANI, Sakai City (JP)

(21) Appl. No.: 16/273,511

(22) Filed: Feb. 12, 2019

(30) Foreign Application Priority Data
Feb. 26, 2018 (JP) 2018-032331

(51) Int. Cl. G02F 1/1335

(52) U.S. Cl. CPC G02F 1/133606; G02F 2201/305; G02F 1/133605; G02F 1/133621

(57) ABSTRACT

A light-emitting device is provided with: at least one laser light source provided with a plurality of laser diodes that emit laser light having mutually different wavelengths; and a diffraction grating arranged at the laser light emission side of the laser light source, in which the diffraction grating is configured so that at least some of the laser light is synthesized directly within a plane separated by a predetermined distance from the diffraction grating.

### BACKGROUND

### 1. Field

The present disclosure relates to a light-emitting device, a backlight device, and a liquid crystal display device.

### 2. Description of the Related Art

Various light-emitting devices that serve as backlight devices using laser light sources have been developed so far. For example, Japanese Unexamined Patent Application Publication No. 2017-134256 (published on Aug. 3, 2017) discloses a configuration with which a uniform planar light source is obtained by having a three-primary-color (for example, RGB, the same hereinafter) laser light source and an enlarging optical system and superposing images for RGB obtained by subjecting the respective laser light to enlargement/beam-shaping as appropriate.

Furthermore, Japanese Unexamined Patent Application Publication No. 2009-231017 (published on Oct. 8, 2009) discloses a configuration with which a planar light source having excellent uniformity is obtained by light from an RGB laser light source entering a light guide plate using a diffractive optical element that is made to oscillate by an actuator.

### SUMMARY

In the configuration of Japanese Unexamined Patent Application Publication No. 2017-134256, there is a problem in that the number of components for the optical system is high, which requires further space.

Furthermore, there is a problem in that there is an increase in the number of components also in the configuration of Japanese Unexamined Patent Application Publication No. 2009-231017 in which an actuator is required.

An aspect of the present disclosure addresses the aforementioned problems of the related art, and provides a light-emitting device that can realize plane emission by means of a simple configuration, a backlight device provided with this light-emitting device, and a liquid crystal display device provided with this backlight device.

In order to address the aforementioned problems, a light-emitting device according to an aspect of the present disclosure is provided with: at least one laser light source provided with a plurality of laser diodes that emit laser light having mutually different wavelengths; and a diffraction grating arranged at a laser light emission side of the laser light source, in which the diffraction grating is configured so that at least some of the laser light is synthesized directly within a plane separated by a predetermined distance from the diffraction grating.

### BRIEF DESCRIPTION OF THE DRAWINGS

FIGS. 1A and 1B are drawings schematically depicting a light-emitting device according to embodiment 1 of the present disclosure, FIG. 1A is a drawing in which one of a plurality of synthesis regions provided on a diffusion plate is seen from the front, and FIG. 1B is a cross-sectional view along line IB-IB in FIG. 1A;

FIG. 2 is an exploded perspective view schematically depicting a liquid crystal display device provided with the light-emitting device of FIGS. 1A and 1B;

FIG. 3 is a front view of the liquid crystal display device schematically depicting a mode of arrangement for the light-emitting device of FIGS. 1A and 1B;

FIGS. 4A and 4B are schematic views depicting an example of the arrangement position of a diffraction grating, FIG. 4A is a top view of a laser light source, and FIG. 4B is a side view of the laser light source;

FIGS. 5A and 5B are drawings depicting an example of a mode of arrangement for laser diodes and mounting substrates in the liquid crystal display device, FIG. 5A is a drawing depicting a mode of arrangement for the laser diodes, and FIG. 5B is a drawing depicting a mode in which the laser diodes depicted in FIG. 5A are mounted on the mounting substrates;

FIGS. 6A and 6B are drawings depicting one modified example of a mode of arrangement for laser diodes and mounting substrates in a liquid crystal display device, FIG. 6A is a drawing depicting a mode of arrangement for the laser diodes, and FIG. 6B is a drawing depicting a mode in which the laser diodes depicted in FIG. 6A are mounted on the mounting substrates;

FIGS. 7A and 7B are drawings depicting another modified example of a mode of arrangement for laser diodes and mounting substrates in a liquid crystal display device, FIG. 7A is a drawing depicting a mode of arrangement for the laser diodes, and FIG. 7B is a drawing depicting a mode in which the laser diodes depicted in FIG. 7A are mounted on the mounting substrates;

FIG. 8 is a drawing schematically depicting a light-emitting device according to embodiment 2 of the present disclosure;

FIG. 9 is a drawing schematically depicting a light-emitting device according to embodiment 3 of the present disclosure;

FIG. 10 is a drawing schematically depicting a light-emitting device according to embodiment 4 of the present disclosure; and

FIG. 11 is a drawing schematically depicting a light-emitting device according to a comparative example.

### DESCRIPTION OF THE EMBODIMENTS

### Embodiment 1

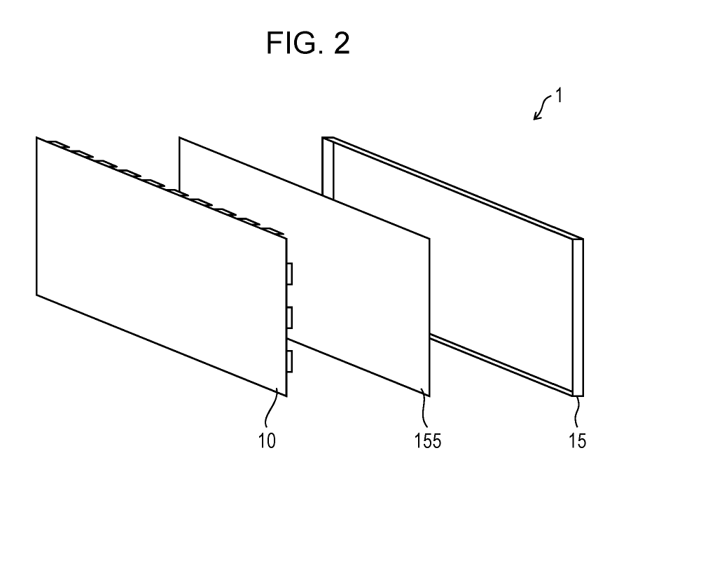

First, a liquid crystal display device provided with a light-emitting device according to one embodiment of the present disclosure will be described with reference to FIG. 2.

(Configuration of Liquid Crystal Display Device)

FIG. 2 is an exploded perspective view schematically depicting a liquid crystal display device 1 provided with a light-emitting device 15 according to embodiment 1 of the present disclosure.

As depicted in FIG. 2, the liquid crystal display device 1 in the present embodiment is provided with a liquid crystal panel 10, a diffusion plate 155, and the light-emitting device (backlight device) 15.

The liquid crystal panel 10 is a display panel that displays images on the basis of input electrical signals. The diffusion plate 155 is provided to diffuse light emitted from the light-emitting device 15 and to emit light efficiently toward the liquid crystal panel 10. The diffusion plate 155 is provided in a position where a synthesis region described hereinafter is formed in a laser light emission direction, for example. In the present embodiment, the material of the diffusion plate 155 is not particularly restricted, and it is sufficient as long as light emitted from the light-emitting device 15 can be diffused. Furthermore, the diffusion plate 155 is formed from a material that transmits light.

Although not depicted, note that, from the viewpoint of enhancing luminance and so forth, a luminance enhancement sheet and an optical member such as a microlens sheet or a prism sheet may be provided as well as the diffusion plate 155 in the present embodiment, and the configuration of the liquid crystal display device 1 is not restricted to the aforementioned configuration.

(Configuration of Light-Emitting Device)

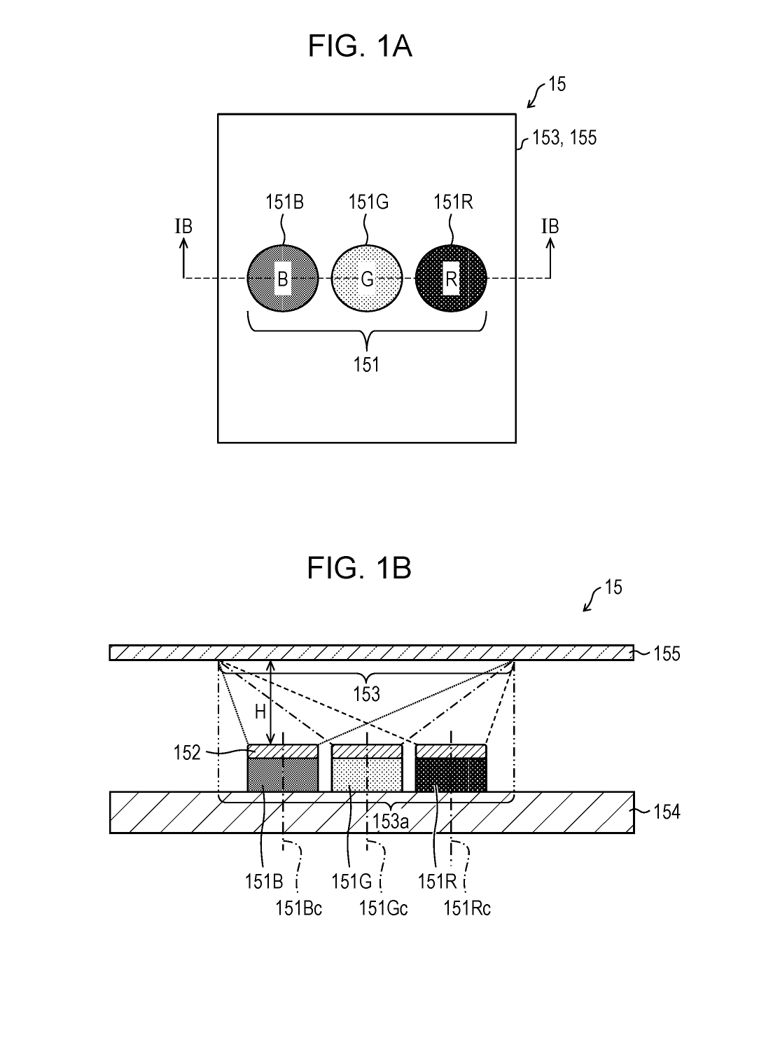

Next, the light-emitting device 15 according to the present embodiment will be described in detail with reference to FIGS. 1A and 1B and FIGS. 3 to 7.

FIGS. 1A and 1B are drawings schematically depicting the light-emitting device 15, FIG. 1A is a drawing in which one of a plurality of synthesis regions 153 provided on the diffusion plate 155 is seen from the front, and FIG. 1B is a cross-sectional view along line IB-IB in FIG. 1A. As depicted in FIGS. 1A and 1B, the light-emitting device 15 is provided with a laser light source 151, diffraction gratings 152, a synthesis region (also referred to as an illumination region or a light-emitting region) 153, and a mounting substrate 154. Furthermore, the diffusion plate 155 is depicted in FIG. 1B.

The laser light source 151 is provided with a laser diode 151B that emits blue laser light having a peak wavelength of 450 nm (B light hereinafter), a laser diode 151G that emits green laser light having a peak wavelength of 520 nm (G light hereinafter), and a laser diode 151R that emits red laser light having a peak wavelength of 638 nm (R light hereinafter), for example.

As depicted in FIG. 1B, three diffraction gratings 152 are arranged at the laser light emission side, corresponding to the laser diodes 151B, 151G, and 151R of the laser light source 151. Furthermore, the three diffraction gratings 152 are formed in positions corresponding respectively to the laser diodes 151B, 151G, and 151R as three diffractive optical elements (also referred to as DOEs), for example. Furthermore, the diffraction gratings 152 are provided on the surfaces of transparent substrates (not depicted) of the diffractive optical elements, for example. The diffraction gratings 152 can diffract radiated light.

In the present embodiment, the diffractive optical elements can be designed according to various conditions such as the spatial distance, light distribution pattern, laser wavelength, or mode of arrangement.

According to the aforementioned configuration, it becomes possible for laser light that is incident on the diffraction gratings 152 (in the present embodiment, B light, G light, and R light, for example) to be subjected to beam-shaping and then to be directly and uniformly synthesized (also referred to as color mixing) in an arbitrary emission shape and intensity distribution state in a plane (diffusion plate 155) separated by a predetermined spatial distance (predetermined spatial distance H in FIG. 1B, for example).

More specifically, as depicted in FIG. 1B, at least some of the laser light subjected to beam-shaping by the diffraction gratings 152 is synthesized directly in the synthesis region 153. In a case where the emitted laser light is B light, G light, and R light, for example, these are synthesized into a uniform white light in the synthesis region 153.

In the present embodiment, the laser diodes 151B, 151G, and 151R are mounted on the mounting substrate 154; however, in the present embodiment, the mounting method is not particularly restricted, and a well-known method may be used.

Furthermore, in the present embodiment, an example is given in which the heights of the laser diodes 151B, 151G, and 151R (the height of a package 151P described hereinafter, for example) are the same; however, this does not restrict the present embodiment. The heights of the laser diodes may be different from each other.

As mentioned above, in the present embodiment, the light-emitting device 15 is provided with the laser light source 151 including the plurality of laser diodes 151B, 151G, and 151R that emit laser light having mutually different wavelengths (the aforementioned B light, G light, and R light, for example), and the diffraction gratings 152 arranged at the laser light emission side (the upper side in FIG. 1B) of the laser light source 151, and the diffraction gratings 152 are configured so that at least some of the laser light is synthesized directly within a plane (a plane including the synthesis region 153) separated by a predetermined distance (the distance H, for example) from the diffraction gratings 152.

According to the aforementioned configuration, it is possible to provide the light-emitting device 15 being able to realize plane emission by means of a simple configuration.

Furthermore, in the present embodiment, a configuration was described in which the diffraction gratings 152 are arranged at the laser light emission side of the laser light source 151; however, more specifically, a configuration may be adopted in which the diffraction gratings 152 are arranged adjacent to the laser light source 151, for example.

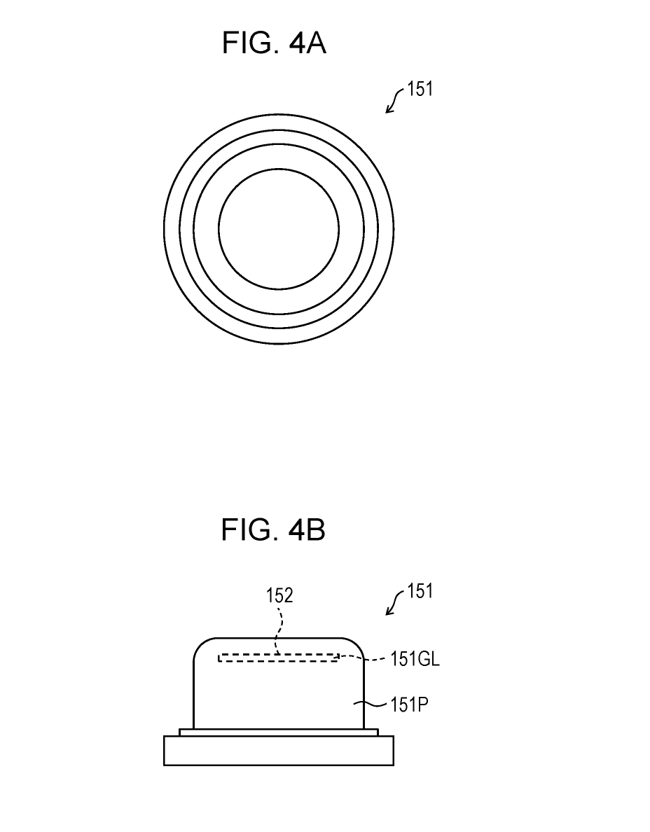

The installation position of the diffraction gratings 152 is not restricted to the aforementioned configuration and can be altered as appropriate. FIGS. 4A and 4B are schematic views depicting an example of the arrangement position of the diffraction gratings 152, FIG. 4A is a top view of the laser light source 151, and FIG. 4B is a side view of the laser light source 151. In the example depicted in FIGS. 4A and 4B, the laser light source 151 is provided with the laser diodes (not depicted in FIGS. 4A and 4B) and the package 151P, which houses the laser diodes, and the diffraction gratings 152 are formed directly on the surface of a piece of glass 151GL that is the laser emission surface of the package 151P. As another example, the laser diodes may be stored in a package that is made of resin, and the diffraction gratings may be formed on the emission surface of the package.

The aforementioned configuration is able to contribute to reducing dimensions in the laser light emission direction of the light-emitting device and also to omitting support members for diffraction gratings, and is therefore also beneficial for reducing the manufacturing cost of the light-emitting device.

Furthermore, in FIGS. 1A and 1B, the reference characters 151Bc, 151Gc, and 151Rc respectively indicate the optical axes of the laser diodes 151B, 151G, and 151R. As depicted in FIGS. 1A and 1B, the plurality of laser diodes 151B, 151G, and 151R are arranged in such a way that the optical axes 151Bc, 151Gc, and 151Rc of the respective laser diodes are oriented in the same direction as each other, for example, the laser light emission direction.

According to the aforementioned configuration, the layout design for the constituent members is simplified and the entire light-emitting device becomes a simple structure when compared to the related art. Furthermore, it is possible to reduce the number of optical members, and therefore a space-saving effect can also be obtained.

(Example of Arrangement of Laser Diodes)

Next, an example of the arrangement of the laser diodes according to the present embodiment will be described with reference to FIGS. 1A and 1B and so forth. As depicted in FIGS. 1A and 1B, the plurality of laser diodes are arranged in a two-dimensional manner. Furthermore, the emission centers of the respective laser diodes are positioned within a region 153a obtained by projecting the synthesis region 153 for the respectively corresponding laser light onto the mounting substrate 154.

According to the aforementioned configuration, even in a case where the light-emitting device 15 is arranged in plurality in a one or two-dimensional manner, adjacent light-emitting devices 15 do not interfere with each other. Therefore, a plurality of light-emitting devices 15 can be arranged in plurality without hindrance.

(Laser Light Source Modified Example 1)

In the above description, a configuration was described in which one laser light source 151 is provided with the laser diodes 151B, 151G, and 151R. However, the present disclosure is not restricted thereto. For example, in a situation where high luminance is desired in a light-emitting device, the amount of light from the laser light source may be increased. To respond to this kind of situation, in the present embodiment, it is possible for the quantity of laser diodes included in one laser light source to be increased. A possible example is the addition of one laser diode 151G. As a result, although not depicted, a so-called “RGGB” configuration is realized, in which the one laser light source in the present modified example 1 is provided with one laser diode 151B, two laser diodes 151G, and one laser diode 151R. In other words, a light-emitting device is obtained in which the laser light source 151 has two or more laser diodes of the same color (for example, the laser diodes 151G).

According to the aforementioned configuration, by increasing the number of laser diodes of the same color and sharing the amount of generated heat, it is possible to suppress a concentration in the local generation of heat and to use laser diodes efficiently.

(Laser Light Source Modified Example 2)

Furthermore, in the light-emitting device according to the present disclosure, a configuration may be adopted in which more than three types of laser light having mutually different wavelengths is emitted from the laser diodes. Consequently, for example, by further providing the laser light source with a laser diode that emits yellow laser light (Y light), a configuration having laser light of the four colors of B light, G light, R light, and Y light may be implemented. By doing so, it is possible to improve the luminance of the light emitted from the light-emitting device and the color gamut when light has passed through the liquid crystal panel.

Furthermore, by further providing a laser diode that emits cyan laser light (C light), a configuration having laser light of the four colors of B light, G light, R light, and C light may be implemented.

Furthermore, possible examples of combinations of laser light in other modes are combinations such as a combination of B light, C light, Y light, and R light, a combination of B light, C light, G light, and R light, and a combination of B light, C light, G light, and Y light, for example. In other words, the laser light source 151 has three or more types of the aforementioned laser diodes.

According to the aforementioned configuration, it is possible to improve the color gamut when light emitted from the light-emitting device 15 has passed through the liquid crystal panel 10.

(Laser Light Source Modified Example 3)

Furthermore, from the viewpoint of improving chromaticity variation, counteracting chromaticity drift, dealing with local dimming, and so forth, the light-emitting device 15 according to the present disclosure may have a configuration provided with a control unit that is capable of individually controlling the emission of light by the laser diodes 151B, 151G, and 151R. Here, the control unit may be provided for every single set of the laser diodes 151B, 151G, and 151R, or may be provided for every plurality of sets.

According to the aforementioned configuration, it becomes possible to independently control the output of a laser light source.

(Example of Arrangement of Laser Light Source)

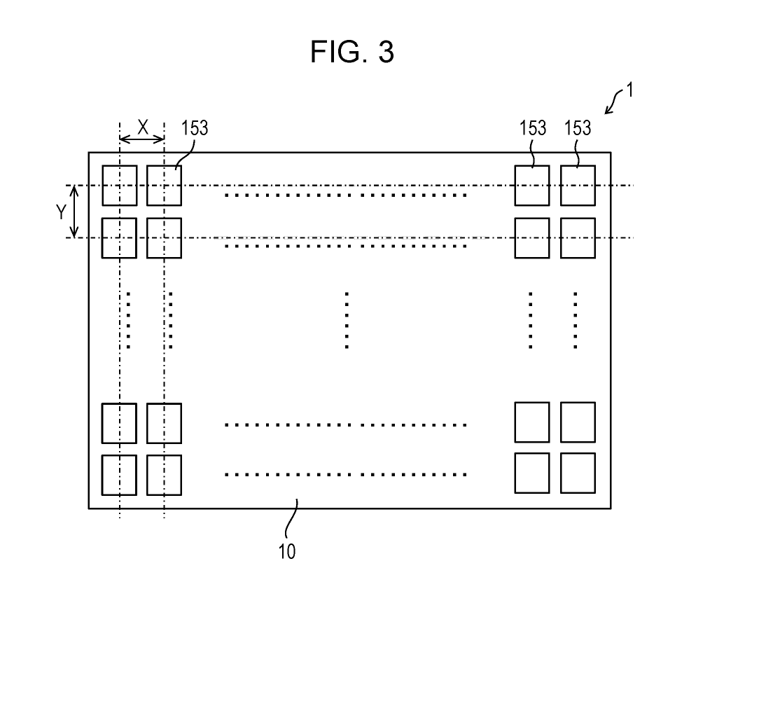

Next, an example of the arrangement of laser light sources according to the present embodiment will be described in detail with reference to FIGS. 3 to 7. FIG. 3 is a front view of the liquid crystal display device 1 schematically depicting a mode of arrangement for the light-emitting device 15 of FIGS. 1A and 1B.

As depicted in FIG. 3, a plurality of light-emitting devices are provided on the liquid crystal panel 10 of the liquid crystal display device 1. Furthermore, in FIG. 3, the reference character X indicates the arrangement pitch in the horizontal direction (horizontal pitch) for the light-emitting devices (only the illumination regions 153 are depicted), and the reference character Y indicates the arrangement pitch in the vertical direction (vertical pitch). Furthermore, the gaps between the light-emitting devices are displayed in an enlarged manner for the convenience of the description; however, arrangements at various pitches and scales are included in the present embodiment. Furthermore, as depicted in FIG. 3, the laser light sources are arranged in a two-dimensional manner at uniform arrangement pitches.

As mentioned above, the light-emitting device 15 has a simple configuration of the laser diodes 151B, 151G, and 151R and the three diffraction gratings 152 corresponding thereto in each of the illumination regions, and it is therefore possible for the illumination regions to be reduced to the size of one laser light source 151 (or the size of the package 151P described hereinafter). Consequently, super-multiple division also becomes possible such that the number of divided areas exceeds 1000, for example.

### Arrangement Example 1

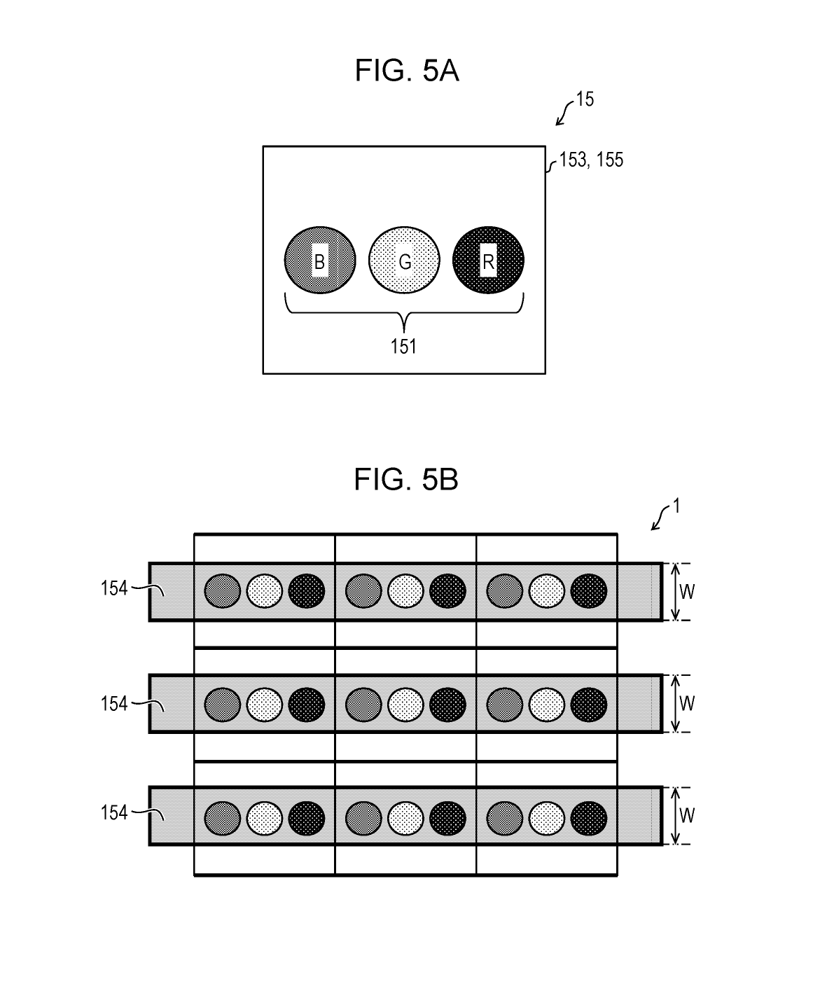

Specifically, FIGS. 5A and 5B are drawings depicting an example of a mode of arrangement for the laser diodes and the mounting substrates 154 in the liquid crystal display device 1, FIG. 5A is a drawing depicting a mode of arrangement for the laser diodes, and FIG. 5B is a drawing depicting a mode in which the laser diodes depicted in FIG. 5A are mounted on the mounting substrates 154.

As depicted in FIG. 5A, one light-emitting device 15 is provided with three laser diodes arranged side-by-side in a single straight line, and, as depicted in FIG. 5B, three light-emitting devices 15 are mounted on mounting substrates 154 side-by-side in a single straight line. FIG. 5B exemplifies an array configuration in which the aforementioned configuration is further arranged in parallel.

According to the aforementioned configuration, the width W of the mounting substrate 154 that is mounted can be reduced, and therefore the cost of the mounting substrate can be reduced.

### Arrangement Example 2

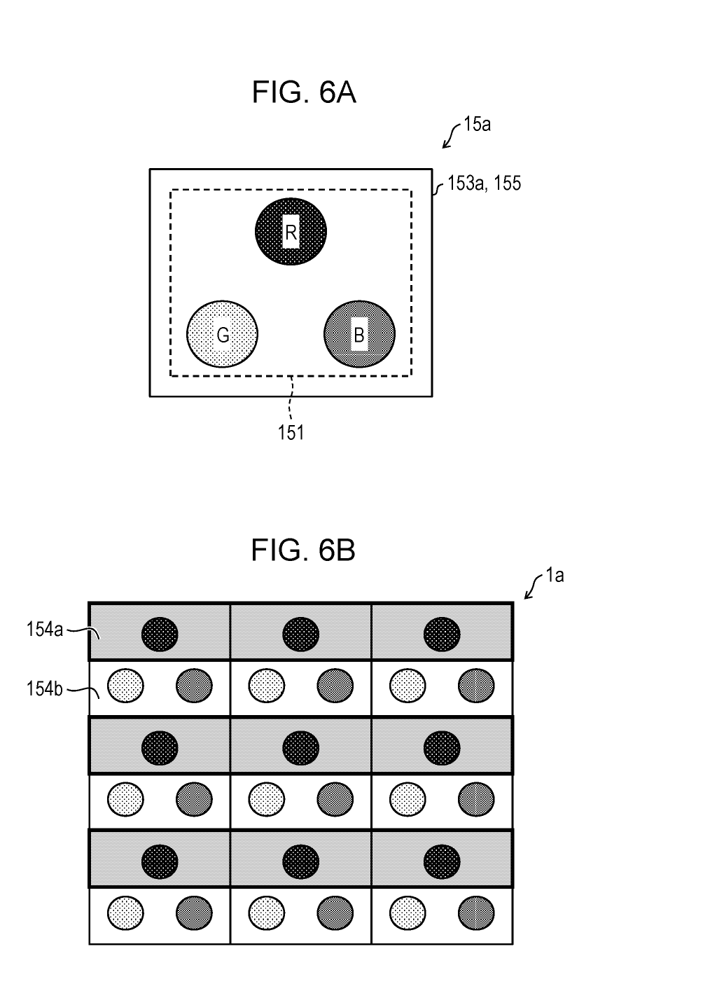

Furthermore, FIGS. 6A and 6B are drawings depicting one modified example of a mode of arrangement for the laser diodes and the mounting substrates 154 in a liquid crystal display device 1a, FIG. 6A is a drawing depicting a mode of arrangement for the laser diodes, and FIG. 6B is a drawing depicting a mode in which the laser diodes depicted in FIG. 6A are mounted on the mounting substrates 154.

As depicted in FIG. 6A, one light-emitting device 15a is provided with three laser diodes arranged in an equilateral-triangular shape, and, as depicted in FIG. 6B, the laser diodes 151R in three light-emitting devices 15a are mounted on mounting substrates 154a side-by-side in a single line, and the laser diodes 151G and 151B in the three light-emitting devices 15a are mounted on mounting substrates 154b side-by-side in a single straight line in an alternating manner. FIG. 6B exemplifies an array configuration in which the aforementioned configuration is further arranged in parallel.

According to the aforementioned configuration, the heat density caused by the generation of heat by the laser diodes can be intentionally altered. For example, by arranging laser diodes R, which have relatively poor temperature characteristics, on the mounting substrates 154a depicted in FIG. 6B, it is possible for it to be less likely that heat from the surroundings will have an effect. Furthermore, by dividing the combination of laser diodes between two mounting substrates as depicted, heat dissipation characteristics can be improved. Furthermore, different materials are used for the mounting substrates 154a and 154b, and therefore the heat dissipation characteristics of the light-emitting devices 15a can be suitably adjusted.

Compared to the aforementioned arrangement example 1, according to the aforementioned configuration, the physical distance between the laser diodes can be increased and therefore the local heat density can be reduced.

### Arrangement Example 3

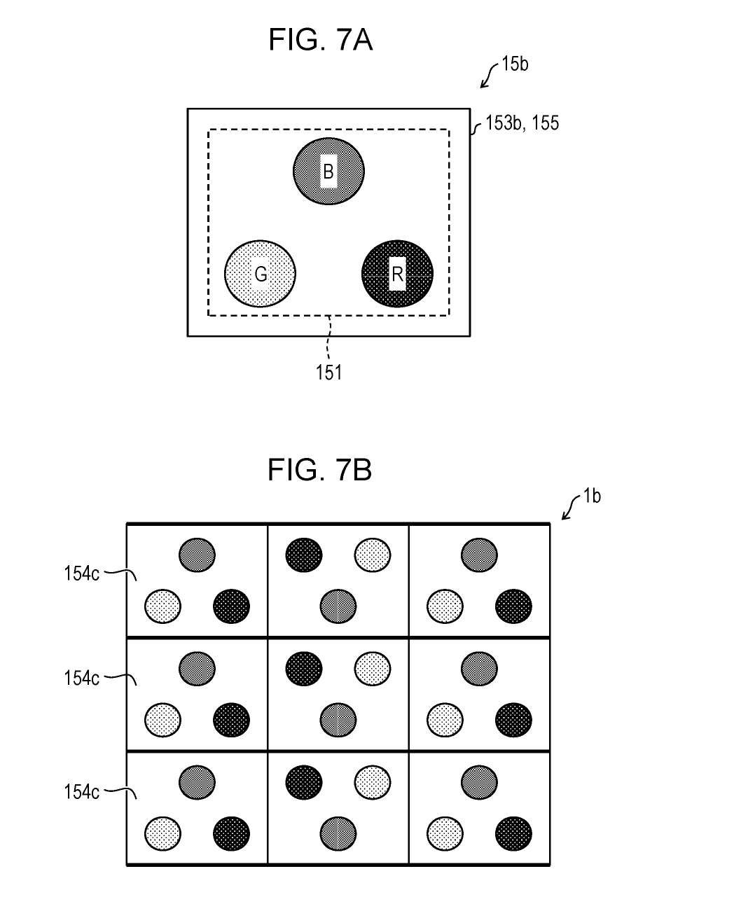

FIGS. 7A and 7B are drawings depicting another modified example of a mode of arrangement for the laser diodes and mounting substrates 154c in a liquid crystal display device 1b, FIG. 7A is a drawing depicting a mode of arrangement for the laser diodes, and FIG. 7B is a drawing depicting a mode in which the laser diodes depicted in FIG. 7A are mounted on the mounting substrates 154c.

Compared to the configuration depicted in FIG. 6A, the configuration of FIG. 7A has different arrangement positions for the laser diode 151B and the laser diode 151R. The rest of the configuration is the same and therefore will not be described. As depicted in FIG. 7B, three light-emitting devices 15b are mounted on a mounting substrate 154c so as to be arranged in a zigzag manner with the horizontal positioning being rotated 180°. FIG. 7B exemplifies an array configuration in which the aforementioned configuration is further arranged in parallel.

Compared to the aforementioned arrangement example 2, according to the aforementioned configuration, the heat density can be further averaged, and therefore balance can be achieved in such a way that local heat generation does not occur.

Furthermore, the configuration depicted in FIG. 7A has been described in the present arrangement example; however, there is no restriction thereto, and it is also possible to apply a configuration in which the laser diode 151B and the laser diode 151R are interchanged, such as that depicted in FIG. 6A, for example.

### Embodiment 2

Another embodiment of the light-emitting device of the present disclosure will be described hereinafter. Note that, for convenience of the description, members having the same functions as the members described in the aforementioned embodiment are denoted by the same reference characters and descriptions thereof will not be repeated.

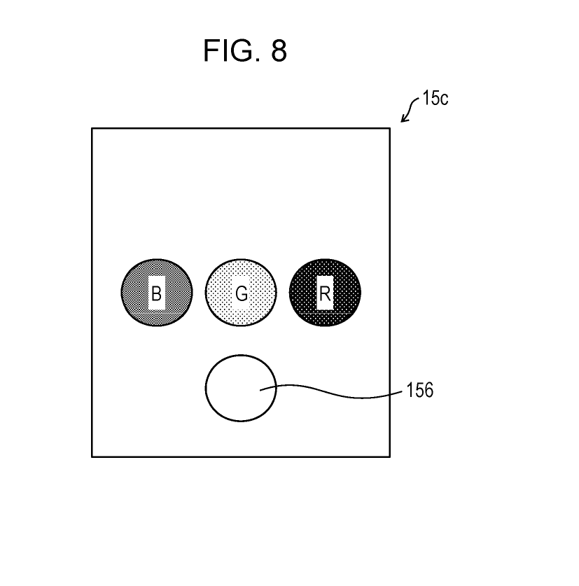

Next, the light-emitting device according to the present embodiment will be described in detail with reference to FIG. 8. FIG. 8 is a drawing schematically depicting a light-emitting device 15c according to the present embodiment.

As depicted in FIG. 8, in the present embodiment, the light-emitting device 15c is the same as in embodiment 1 apart from being provided with a color sensor 156, and therefore the color sensor 156 will be selectively described hereinafter.

The light-emitting device 15c also has a control unit that is not depicted. The color sensor 156 receives some of the laser light that is reflected by the diffusion plate 155, for example. Furthermore, the control unit independently controls each laser diode so that the received laser light becomes a predetermined color. In other words, the light-emitting device 15c has the color sensor 156, and controls the emission of light of at least any of the plurality of laser diodes, on the basis of a detection result produced by the color sensor 156. Here, a control unit that controls light emission may also be provided for every illumination region or may be provided for every plurality of illumination regions. Furthermore, the color sensor 156, for example, can be configured using a photodiode, a color filter, or the like; however, other configurations may be adopted such as arranging a photodiode inside the laser light source 151.

According to the aforementioned configuration, it is possible to control the luminance and chromaticity of a light-emitting device by controlling the amount of light emitted from each laser light source.

### Embodiment 3

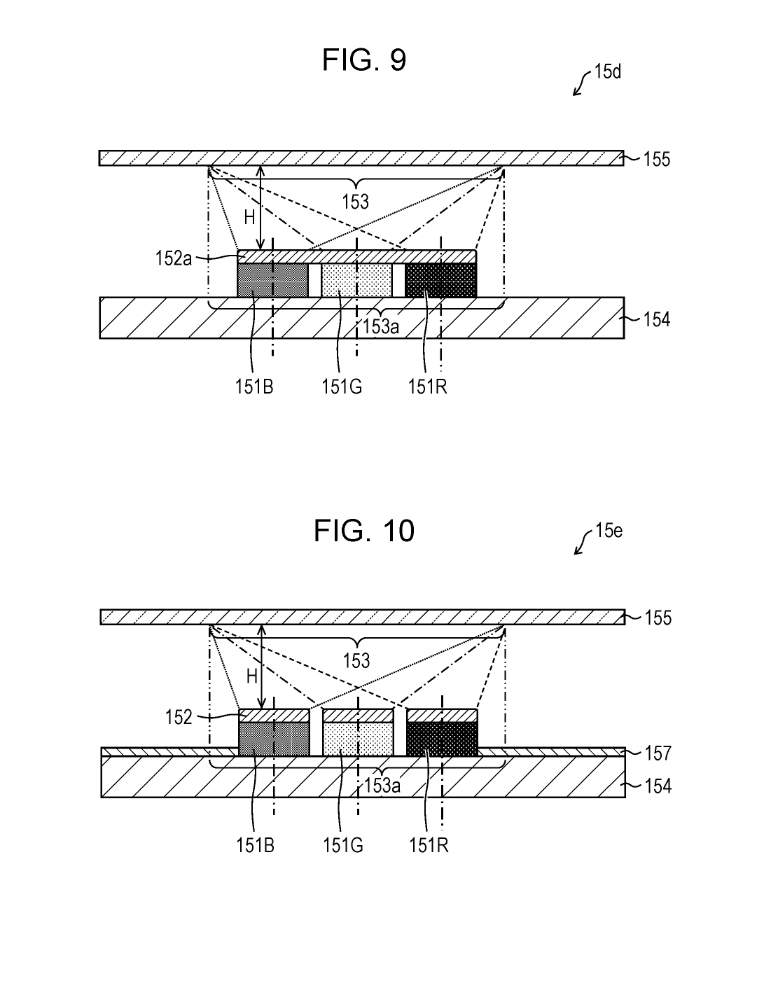

Next, a light-emitting device according to the present embodiment will be described in detail with reference to FIG. 9. FIG. 9 is a drawing schematically depicting a light-emitting device 15d according to the present embodiment.

As depicted in FIG. 9, in the present embodiment, the light-emitting device 15d is provided with an integrated diffraction grating 152a. Other points are the same as in embodiment 1, and therefore the diffraction grating 152a will be selectively described hereinafter.

In the present embodiment, for example, the integrated diffraction grating 152a is provided so as to correspond to each laser diode.

According to the aforementioned configuration, the same effect as that of embodiment 1 can be demonstrated. Furthermore, the diffraction grating 152a being integrated can thereby contribute also to simplifying the support members therefor, and is also beneficial for reducing the manufacturing cost of the light-emitting device.

### Embodiment 4

Next, a light-emitting device according to the present embodiment will be described in detail with reference to FIG. 10. FIG. 10 is a drawing schematically depicting a light-emitting device 15e according to the present embodiment.

As depicted in FIG. 10, in the present embodiment, the light-emitting device 15e is the same as in embodiment 1 apart from being further provided with a reflection sheet 157, and therefore the reflection sheet 157 will be selectively described hereinafter.

As depicted in FIG. 10, the reflection sheet 157 is provided in regions of the mounting substrate 154 in which a laser light source 151 is not arranged, for example. The material of the reflection sheet 157 is not particularly restricted, and it is sufficient as long as light reflected toward the mounting substrate 154 side can be reflected toward the illumination side.

According to the aforementioned configuration, the same effect as that of embodiment 1 can be demonstrated. Furthermore, by providing the reflection sheet 157, the light emission efficiency of the light-emitting device can be further improved.

Note that the configuration of the present embodiment in which a reflection sheet is provided can naturally be applied also to the aforementioned embodiments 1 to 3.

### Comparative Example

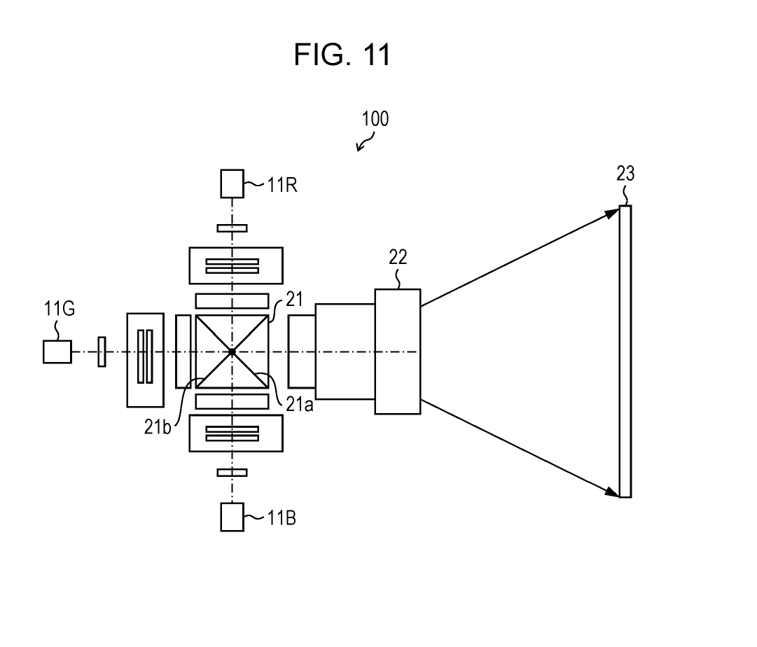

FIG. 11 is a drawing schematically depicting a light-emitting device 100 according to a comparative example. As depicted in FIG. 11, the light-emitting device 100 is configured from light sources 11 (11B, 11G, and 11R), a synthesis optical system 21, a projection optical system 22, a screen 23, and the like. The synthesis optical system 21 synthesizes light that is emitted from the light sources 11 arranged around the synthesis optical system 21.

When the configuration of the present comparative example and the configuration of the present disclosure are compared, there are few constituent members for the light-emitting device in the aforementioned embodiments of the present disclosure, and therefore there is an advantage in that it is possible to provide a light-emitting device having a simple configuration.

### SUMMARY

A light-emitting device (15) according to aspect 1 of the present disclosure is provided with: at least one laser light source (151) provided with a plurality of laser diodes that emit laser light having mutually different wavelengths; and a diffraction grating (152) arranged at the laser light emission side of the laser light source (151), in which the diffraction grating (152) is configured so that at least some of the laser light is synthesized directly within a plane (a plane including the synthesis region 153) separated by a predetermined distance (H) from the diffraction grating (152).

According to the aforementioned configuration, it is possible to provide a light-emitting device (15) that is able to realize plane emission by means of a simple configuration.

For a light-emitting device (15) according to aspect 2 of the present disclosure, in the aforementioned aspect 1, the diffraction grating (152) may be arranged adjacent to the laser light emission side with respect to the laser light source (151).

For a light-emitting device (15) according to aspect 3 of the present disclosure, in the aforementioned aspect 2, the diffraction grating (152) may be formed in a package (151P) that houses the laser diodes.

The configurations of the aforementioned aspects 2 and 3 are able to contribute to reducing dimensions in the laser light emission direction of the light-emitting device and also to omitting support members for diffraction gratings, and are therefore also beneficial for reducing the manufacturing cost of the light-emitting device.

For a light-emitting device (15) according to aspect 4 of the present disclosure, in any one of the aforementioned aspects 1 to 3, the plurality of laser diodes may be arranged so that the optical axes of the respective laser diodes are oriented in mutually identical directions.

According to the aforementioned configuration, the layout design for the constituent members is simplified and the entire light-emitting device becomes a simple structure when compared to the related art. Furthermore, it is possible to reduce the number of optical members, and therefore a space-saving effect can also be obtained.

For a light-emitting device (15) according to aspect 5 of the present disclosure, in any one of the aforementioned aspects 1 to 4, the laser light source (151) may be arranged in plurality in a two-dimensional manner.

According to the aforementioned configuration, it is possible for each illumination region to be reduced to the size of one laser light source (151). Consequently, super-multiple division also becomes possible such that the number of divided areas exceeds 1000, for example.

For a light-emitting device (15) according to aspect 6 of the present disclosure, in any one of the aforementioned aspects 1 to 5, the plurality of laser diodes may be arranged in a two-dimensional manner, and the emission centers of the respective laser diodes may be positioned within a region obtained by projecting a synthesis region (153) for corresponding laser light.

According to the aforementioned configuration, even in a case where light-emitting devices are arranged in plurality in a one or two-dimensional manner, adjacent light-emitting devices do not interfere with each other. Therefore, a plurality of light-emitting devices can be arranged in plurality without hindrance.

For a light-emitting device (15) according to aspect 7 of the present disclosure, in any one of the aforementioned aspects 1 to 6, the laser light source (151) may have two or more of the laser diodes having identical wavelengths.

According to the aforementioned configuration, by increasing the number of laser diodes having the same wavelength and sharing the amount of generated heat, it is possible to suppress a concentration in the local generation of heat and to use laser diodes efficiently.

For a light-emitting device (15) according to aspect 8 of the present disclosure, in any one of the aforementioned aspects 1 to 7, the laser light source (151) may have three or more types of the laser diodes.

According to the aforementioned configuration, it is possible to improve the color gamut when light emitted from the light-emitting device (15) has passed through the liquid crystal panel (10).

For a light-emitting device (15) according to aspect 9 of the present disclosure, in any one of the aforementioned aspects 1 to 8, it may be possible for at least one output of the laser light source (151) to be independently controlled.

According to the aforementioned configuration, it becomes possible to independently control the output of the laser light source at least.

For a light-emitting device (15) according to aspect 10 of the present disclosure, in any one of the aforementioned aspects 1 to 9, there may also be a color sensor (156), and the emission of light of at least any of the plurality of laser diodes may be controlled based on a detection result produced by the color sensor (156).

According to the aforementioned configuration, it is possible to control the luminance and chromaticity of a light-emitting device by controlling the amount of light emitted from each laser light source.

For a light-emitting device (15) according to aspect 11 of the present disclosure, in any one of the aforementioned aspects 1 to 10, there may also be provided a reflection member (157) that causes light reflected toward the side opposite the emission side to be reflected toward the emission side.

According to the aforementioned configuration, in addition to it being possible for the same effect as that of aspect 1 to be demonstrated, by providing the reflection member (157), it is possible for the light emission efficiency of the light-emitting device to be further improved.

A backlight device according to aspect 12 of the present disclosure is provided with the light-emitting device according to any one of the aforementioned aspects 1 to 11.

According to the aforementioned configuration, the same effect as that of aspect 1 can be demonstrated.

A liquid crystal display device according to aspect 13 of the present disclosure is provided with the backlight device according to the aforementioned aspect 12.

According to the aforementioned configuration, the same effect as that of aspect 1 can be demonstrated.

The present disclosure is not restricted to the aforementioned embodiments, various alterations are possible within the scope indicated in the claims, and embodiments obtained by appropriately combining the technical means disclosed in each of the different embodiments are also included within the technical scope of the present disclosure. In addition, novel technical features can be formed by combining the technical means disclosed in each of the embodiments.

The present disclosure contains subject matter related to that disclosed in Japanese Priority Patent Application JP 2018-032331 filed in the Japan Patent Office on Feb. 26, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A light-emitting device comprising:
at least one laser light source provided with a plurality of laser diodes that emit laser light having mutually different wavelengths; and
a diffraction grating arranged at a laser light emission side of the laser light source,
wherein the diffraction grating is configured so that at least some of the laser light is synthesized directly within a plane separated by a predetermined distance from the diffraction grating.

2. The light-emitting device according to claim 1,
wherein the diffraction grating is arranged adjacent to the laser light emission side with respect to the laser light source.

3. The light-emitting device according to claim 2,
wherein the diffraction grating is formed in a package that houses the laser diodes.

4. The light-emitting device according to claim 1,
wherein the plurality of laser diodes are arranged so that optical axes of the respective laser diodes are oriented in mutually identical directions.

5. The light-emitting device according to claim 1,
wherein the laser light source is arranged in plurality in a two-dimensional manner.

6. The light-emitting device according to claim 1,
wherein the plurality of laser diodes are arranged in a two-dimensional manner, and emission centers of the respective laser diodes are positioned within a region obtained by projecting a synthesis region for corresponding laser light.

7. The light-emitting device according to claim 1,
wherein the laser light source has two or more of the laser diodes having identical wavelengths.

8. The light-emitting device according to claim 1,
wherein the laser light source has three or more types of the laser diodes.

9. The light-emitting device according to claim 1,
wherein it is possible for at least one output of the laser light source to be independently controlled.

10. The light-emitting device according to claim 1,
further comprising a color sensor,
wherein emission of light of at least any of the plurality of laser diodes is controlled based on a detection result produced by the color sensor.

11. The light-emitting device according to claim 1,
further comprising a reflection member that causes light reflected toward a side opposite the emission side to be reflected toward the emission side.

12. A backlight device comprising the light-emitting device according to claim 1.

13. A liquid crystal display device comprising the backlight device according to claim 12.
